(19) United States
(12) Patent Application Publication
(10) Pub. No.: US 2008/0185467 A1
(43) Pub. Date: Aug. 7, 2008

(54) Food Processor Having Gear-Shifting Function

(76) Inventor: LI-CHEN WU CHANG, Pa Te Hsiang (TW)

Correspondence Address: RABIN & Berdo, PC, 1101 14TH STREET, NW, SUITE 500, WASHINGTON, DC, 20005, US

(21) Appl. No.: 11/671,039

(22) Filed: Feb. 5, 2007

(51) Int. Cl. B02C 23/00

(52) U.S. Cl. 241/285.1

(57) ABSTRACT

A food processor having gear-shifting function includes a machine body, gear-shifting and non-gear-shifting cutting assemblies. Each of the cutting assemblies includes a fixed seat and a rotating seat. The rotating seat is assembled onto the fixed seat via a shaft and a bearing, so that the rotating seat is able to freely rotate relatively to the fixed seat. The non-gear-shifting cutting assembly is not mounted with the gear-shifting mechanism; therefore, when the cutting assembly is installed on the drive shaft of the motor, the cutting assembly is to output at the same speed as that of the motor. The gear-shifting cutting assembly is disposed with a gear-shifting mechanism in the fixed seat. Therefore, when the drive shaft of the motor rotates, the shaft is to rotate by the gear-shifting output via the gear-shifting mechanism, which makes the blade mounted on the rotating seat to rotate at a gear-shifted speed.

### BACKGROUND OF THE INVENTION

1. Field of the Invention

The present invention is generally related to a food processor, and in particular to a cutting assembly design having interchangeable non-gear-shifting and gear-shifting cutting assemblies for a food processor.

2. The Prior Arts

Typical conventional food processors generally have only a single function. For example, a conventional juicer only has the function of extracting juice, and does not possess the function of cutting vegetables or grinding meat. If a food processor were to simultaneously possess the three aforementioned functions, three types of cutting assemblies in the form of blades/disc assemblies need to be equipped. In addition, even if a food processor is equipped with many types of cutting assemblies, the motor that is mounted on the food processor can only be used to provide with one speed, and cannot provide a proper speed based on the different functions such as extracting juice, cutting vegetables, and grinding meat. If a multiple-speed mechanism were to be installed in a food processor, such food processor will be much larger, heavier, and to be of higher manufacturing cost.

### SUMMARY OF THE INVENTION

A primary objective of the present invention is to solve the drawback of the traditional food processor having more complicated structure, much larger volume, and higher costs when multiple speed functions are provided.

A main feature of the present invention is to design special interchangeable cutting assemblies of gear-shifting and non-gear shift types based on the features of the food, whereby the user can choose a different motor drive shaft for mounting in the food processor to process the food in the most appropriate manner as known by one skilled in the art.

The cutting assemblies, in the form of a blade assembly or a disc assembly, of gear-shifting and non-gear-shifting types of the present invention both comprises a fixed seat and a rotating seat; and the rotating seat is assembled onto the fixed seat via a shaft and a bearing, so that the rotating seat could rotate relative with respect to the fixed seat. The non-gear-shifting cutting assembly does not include a gear-shifting mechanism, so that when the cutting assembly is installed on the drive shaft of the motor, the cutting assembly is to rotate at the same speed as the motor. On the other hand, the gear-shifting cutting assembly is formed with a gear-shifting mechanism in the fixed seat. Therefore, when the drive shaft of the motor rotates, the shaft is rotated by means of the gear shifting output via the gear-shifting mechanism, which then further makes the blades (cutting assembly) mounted on the rotating seat to rotate in a gear-shifted manner.

The solution of the non-gear-shifting cutting assembly in accordance with the present invention comprises a fixed seat and a rotating seat; and the rotating seat is coupled with a blade and a shaft. The shaft is disposed and secured in the fixed seat via a bearing. The shaft arranged in the fixed seat is fitted with a passive joint which can be connected with an active joint disposed on the drive shaft of the motor. And the same output speed as the motor can be achieved when the two joints are connected/interlocked.

The solution of the gear-shifting cutting assembly in accordance with the present invention comprises a hollowed fixed seat and a rotating seat, in which a gear-shifting mechanism is found inside the rotating seat. The gear-shifting mechanism includes a drive shaft, a first joint attached at one end of the drive shaft, and a second joint coupled to the gear-shifting mechanism. The drive shaft is coupled to the fixed seat via a bearing. The rotating seat comprises a blade and a shaft; and the shaft is coupled with a passive joint to connect with the second joint. The fixed seat is mounted to the drive shaft of the motor of the food processor, thereby making the first joint to be connected to the joint arranged on the drive shaft. Therefore, when the drive shaft is rotated by the rotation of the motor, the shaft is able to rotate at the gear shifting output via the gear-shifting mechanism, thereby further making the blade to rotate at a gear-shifted speed.

The solution of the gear-shifting mechanism of the present invention is that the inner diameter of the fixed seat is disposed with an internal tooth ring, and the drive shaft is disposed with a sun gear. And a planetary disk and a plurality of planetary gears are disposed inside the fixed seat, in which the planetary disk is pivotally-connected to the drive shaft; and the second joint is arranged on the planetary disk; and the planetary gears are pivotally-connected to the planetary disk. The planetary gears, at the same time, are engaged with the internal tooth ring and the sun gear. Hence, when the drive gear is driven to rotate, the planetary gears are brought to rotate along the internal tooth ring in an encircled manner, thereby making the planetary disk to rotate at a reduced rotational speed; and the planetary disk will bring along the rotation of the rotating seat via the second joint and the passive joint for achieving the goal of changing the angular velocity.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing a non-gear-shifting cutting assembly constructed in accordance with an embodiment of the present invention;

FIG. 2 is a cross-sectional view showing the non-gear-shifting cutting assembly constructed in accordance with the embodiment of the present invention;

FIG. 3 is a perspective view showing a gear-shifting cutting assembly constructed in accordance with an another embodiment of the present invention; and

FIG. 4 is a cross-sectional view showing the gear-shifting cutting assembly constructed in accordance with the another embodiment of the present invention.

### DETAILED DESCRIPTION OF THE PREFERRED EMBODIMENT

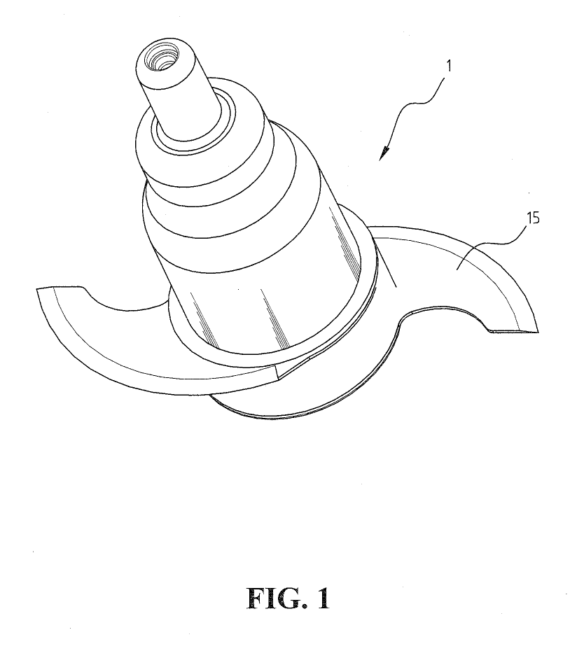

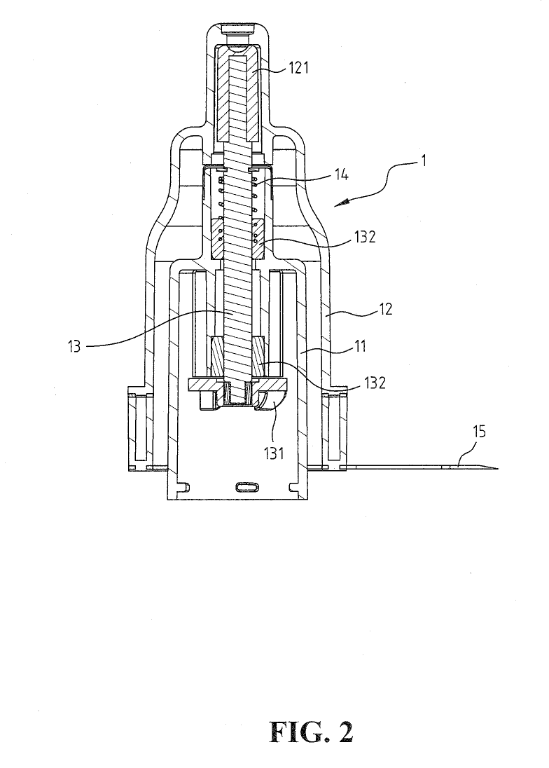

FIGS. 1 and 2 show the structure of a cutting assembly 1 of the non-gear-shifting type constructed in accordance with an embodiment of the present invention. The cutting assembly 1, in the non-gear-shifting format, comprises a fixed seat 11 in a hollow cylindrical body, and a rotating seat 12. A shaft 13 is arranged inside of the fixed seat 11 to cooperate in conjunction with two bearings 132, for thereby making the shaft 13 to rotate freely in relation to the fixed seat 11. One end of the shaft 13 arranged in the fixed seat is coupled with a passive joint 131; and the passive joint 131 is able to be engaged with an active joint (not shown) disposed on the drive shaft of a motor. The other end of the shaft 11 that is extending out from the fixed seat 11 is coupled with a rotating seat 12 by means of a bushing 121. A plurality of blades, such as meat-grinding blades 15, are disposed at a plurality of proper positions around the rotating seat. A spring 14 can be disposed between one of the bearing 132 and the upper portion inside the fixed seat so that the rotating seat 12 is able to resiliently rotate axially. After the cutting assembly 1 is mounted on the drive shaft of the motor of the food processor, the passive joint 131 is to engage directly with the active joint arranged and coupled on the drive shaft. Therefore, when the motor is rotating, the drive shaft is to bring along the rotation of the shaft 13, while making the meat-grinding blade 15 to rotate at the same rotational speed as the drive shaft of the motor, so that no gear-shifting has taken place.

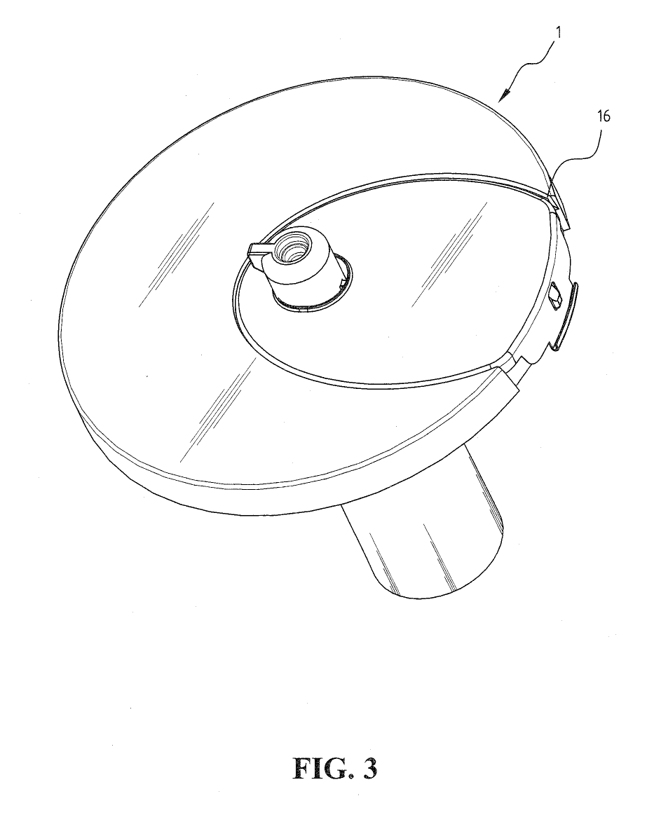

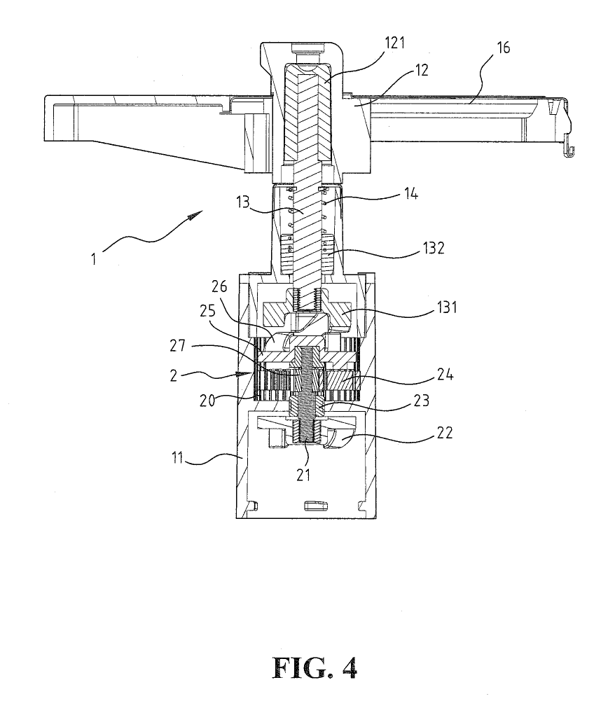

FIGS. 3 and 4 show the structure of another cutting assembly 1 constructed in accordance with another embodiment of the present invention in the form of a gear-shifting disc assembly. The gear-shifting disc assembly of the embodiment comprises a fixed seat 11 in the form of a hollow cylinder, and a rotating seat 12. The hollowed inside portion of the fixed seat 11 is fitted with a gear-shifting mechanism 2, which includes a drive shaft 21, a sun gear 27 disposed on the drive shaft 21, a planetary disk 25, a plurality of planetary gears 24, a first joint 22 disposed on one end of the drive shaft 21, and a second joint 26 disposed on the planetary disk 25. The drive shaft 21 is connected to the fixed seat 11 via a bearing 23, thereby making the drive shaft 21 to rotate with respect to and around the fixed seat 11. The inner diameter of the fixed seat 11 is disposed with an internal tooth ring 20. The planetary disk 25 is arranged at a proper position of the drive shaft 21 of the shaft 13. The planetary disk 25 is pivotally-connected to a plurality of planetary gears 24, while each planetary gear 24 is engaged with the internal tooth ring 20. The fixed seat 11 is mounted with a shaft 13 to work in cooperation with the bearing 132. One end of the shaft 13 extended into the fixed seat 11 is coupled with a passive joint 131; and the passive joint 131 is engaged with the second joint 26. And the other end extending out of the fixed seat 11 is formed with a cutting tool, such as a vegetable-cutting blade 16, to cooperate with the bushing 121. A spring 14 can be disposed between one of the bearing 132 and the upper portion inside the fixed seat, so that the rotating seat 12 is able to resiliently rotate axially.

After the cutting assembly 1 is mounted on the drive shaft of the motor of the food processor, the first joint 22 is to engage directly with the active joint arranged on the drive shaft (not shown). Therefore, when the motor is rotated, the drive shaft of the motor is able to direct drive the rotation of the drive shaft 21; and the sun gear 27 is to bring along the rotation of the planetary gears 24 along the internal tooth ring 20 in an encircled manner, thereby followed by the reduced rotational speed of the planetary disk 25; the second joint 26 mounted on the planetary disk 25 will then bring along the rotation of the shaft 13 via the passive joint 132, whereby making the vegetable-cutting blade 16 and the rotating seat 12 rotate at a different speed from the rotational speed of the motor.

Hence, when a user is using a food processor, the non-gear-shifting cutting assembly or the gear-shifting cutting assembly can be chosen based on the requirements of the type of food to be processed. For example, when grinding meat, the cutting/blade assembly as shown in FIGS. 1 and 2 can be selected. On the other hand, if a lower-speed disc assembly is needed for cutting vegetables or extracting juice, the cutting/disc assembly as shown in FIGS. 3 and 4 can be selected.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A food processor having gear-shifting function, comprising:
a machine body having a drive shaft and a motor;
a non-gear-shifting cutting assembly having a fixed seat and a rotating seat, wherein the rotating seat comprises a blade and a shaft, the shaft mounted at the fixed seat through working in cooperation with a bearing, and a passive joint is coupled to the shaft inside the fixed seat;
a gear-shifting cutting assembly having a rotating seat and a hollow cylindrical fixed seat, the hollow cylindrical fixed seat having a gear-shifting mechanism comprising a drive shaft, a first joint disposed at one end of the drive shaft, and a second joint coupled to the gear-shifting mechanism, the drive shaft connected to the fixed seat via a bearing, the rotating seat comprising a blade and a shaft, and the shaft having a passive joint to connect with the second joint.

2. The food processor as claimed in claim 1, wherein the gear-shifting mechanism further comprises an internal tooth ring disposed on the inner diameter of the fixed seat, a sun gear disposed on the drive shaft, a planetary disk, and a plurality of planetary gears, wherein the planetary disk is pivotally-connected to the drive shaft, the second joint is arranged on the planetary disk, the planetary gears are pivotally-connected to the planetary disk, and the planetary gears are engaged with the internal tooth ring and the sun gear.

3. A food processor having gear-shifting function, comprising:
a machine body having a drive shaft and a motor;
a plurality of gear-shifting cutting assemblies, each having a rotating seat and a fixed seat; wherein the fixed seat is of a hollow cylinder; the fixed seat is fitted with a gear-shifting mechanism, and the gear-shifting mechanism comprises a drive shaft, a first joint attached at one end of the drive shaft, and a second joint disposed on the gear-shifting mechanism, the drive shaft connected to the fixed seat via a bearing, the rotating seat comprising a blade and a shaft, and the shaft disposed with a passive joint to connect with the second joint.

4. The food processor as claimed in claim 3, wherein the gear-shifting mechanism further comprises an internal tooth ring disposed on the inner diameter of the fixed seat, a sun gear disposed on the drive shaft, a planetary disk, and a plurality of planetary gears, wherein the planetary disk is pivotally-connected to the drive shaft, the second joint is arranged on the planetary disk, the planetary gears are pivotally-connected to the planetary disk, and the planetary gears are engaged with the internal tooth ring and the sun gear.
